(19) United States
(12) Patent Application Publication
(10) Pub. No.: US 2025/0384829 A1
(43) Pub. Date: Dec. 18, 2025

(54) DISPLAY DEVICE, OPERATION METHOD OF SENSING UNIT INCLUDED THEREIN, AND ELECTRONIC DEVICE INCLUDING THE SAME

(71) Applicant: Samsung Display Co., LTD., Yongin-si (KR)

(72) Inventors: Dae Gwang JANG, Yongin-si (KR); Kuk Hwan AHN, Yongin-si (KR); Seung Jae LEE, Yongin-si (KR); Seong Heon CHO, Yongin-si (KR)

(21) Appl. No.: 19/027,881

(22) Filed: Jan. 17, 2025

(30) Foreign Application Priority Data
Jun. 18, 2024 (KR) 10-2024-0078857
Sep. 4, 2024 (KR) 10-2024-0119848

(51) Int. Cl. G09G 3/3233

(52) U.S. Cl. CPC G09G 3/3233; G09G 2300/0819; G09G 2300/0852; G09G 2310/08; G09G 2320/045

(57) ABSTRACT

A display device includes a display panel including blocks, each including sub-pixels, and a sensing unit connected to a first block among the blocks via a sensing line and including a sensing capacitor. The sensing line includes a first sub-sensing line connected to sub-pixels which emit light in a first color among sub-pixels included in the first block and a second sub-sensing line connected to sub-pixels which emit light in a second color among the sub-pixels included in the first block. The sensing unit includes a first initialization switch connected between a first initialization voltage node, to which a first initialization voltage is applied, and the first sub-sensing line and a second initialization switch connected between a second initialization voltage node, to which a second initialization voltage is applied, and the second sub-sensing line, and the first initialization voltage and the second initialization voltage may be different from each other.

The application claims priority to Korean Patent Application No. 10-2024-0078857, filed on Jun. 18, 2024, and Korean Patent Application No. 10-2024-0119848, filed on Sep. 4, 2024, and all the benefits accruing therefrom under 35 U.S.C. § 119, the contents of which in their entirety are herein incorporated by reference.

### BACKGROUND

### 1. Field

Embodiments of the disclosure relate to a display device, an operation method of a sensing unit included in the display device, and an electronic device including the display device.

### 2. Description of the Related Art

A display device generally includes pixels, and each of the pixels may include a driving transistor that transmits a driving current to a light-emitting element, and the light-emitting element that emits light with brightness corresponding to the driving current.

The electrical characteristics of the pixel, such as the threshold voltage of the driving transistor and the threshold voltage of the light-emitting element, are the factors that determine the driving current, and the electrical characteristics of the pixel may vary due to various causes such as process variation, aging, or the like.

The display device may sense the electrical characteristics of the pixels to compensate for a change in the electrical characteristics of the pixels.

### SUMMARY

Embodiments of the disclosure provide a display device capable of more accurately sensing the electrical characteristics of pixels.

Embodiments of the disclosure are not limited to the embodiments set forth herein, and other embodiments not described herein may be clearly understood by a person skilled in the art from the following description.

A display device according to embodiments of the disclosure includes a display panel including a plurality of blocks, where each of the blocks includes a plurality of sub-pixels, and a sensing unit connected to a first block among the blocks via a sensing line, where the sensing unit includes a sensing capacitor, where the sensing line includes a first sub-sensing line connected to sub-pixels which emit light in a first color among sub-pixels included in the first block and a second sub-sensing line connected to sub-pixels which emit light in a second color different from the first color among the sub-pixels included in the first block, the sensing unit further includes a first initialization switch connected between a first initialization voltage node, to which a first initialization voltage is applied, and the first sub-sensing line and a second initialization switch connected between a second initialization voltage node, to which a second initialization voltage is applied, and the second sub-sensing line, and the first initialization voltage and the second initialization voltage may be different from each other.

In embodiments, the sensing line may further include a third sub-sensing line connected to sub-pixels which emit light in a third color different from the first color and the second color among the sub-pixels included in the first block, the sensing unit may further include a third initialization switch connected between a third initialization voltage node, to which a third initialization voltage is applied, and the third sub-sensing line, and the first initialization voltage, the second initialization voltage, and the third initialization voltage may be different from each other.

In embodiments, the first to third initialization switches may be turned on in response to a voltage application signal applied during an active interval of a frame.

In embodiments, the sensing unit may further include a first selection switch connected between the first sub-sensing line and a sensing node, where the first selection switch is turned on in response to a first selection signal, a second selection switch connected between the second sub-sensing line and the sensing node, where the second selection switch is turned on in response to a second selection signal, and a third selection switch connected between the third sub-sensing line and the sensing node, where the third selection switch is turned on in response to a third selection signal, and the first to third selection signals may be applied during a blank interval after the active interval.

In embodiments, the sensing unit may further include a reset switch connected between the sensing node and a ground power supply, where the reset switch is turned on in response to a reset signal, and the sensing capacitor connected between the sensing node and the ground power supply.

In embodiments, the sensing unit may further include an analog front-end, to which the sensing node and a driving voltage node are connected at an input end thereof, and an analog-to-digital converter which converts a voltage output from the analog front-end into a data value.

In embodiments, when the first selection switch is turned on, a first driving voltage is applied to the driving voltage node, when the second selection switch is turned on, a second driving voltage is applied to the driving voltage node, when the third selection switch is turned on, a third driving voltage is applied to the driving voltage node, and the first to third driving voltages may be different from each other.

In embodiments, the blank interval may include a first interval, a second interval, and a third interval, a data signal corresponding to pattern data may be applied to sub-pixels included in a target sub-pixel row including a target sub-pixel during the first interval, the target sub-pixel may generate a driving current based on the pattern data and the sensing unit may generate sensing data based on the driving current during the second interval after the first interval, and data signals corresponding to image data included in an active interval of a current frame may be applied to the sub-pixels included in the target sub-pixel row during the third interval after the second interval.

In embodiments, the target sub-pixel may generate the driving current based on a data signal corresponding to data having a grey gradation in the pattern data.

In embodiments, the sensing data may include electrical characteristics of the target sub-pixel.

In embodiments, in one frame, the target sub-pixel of each of the blocks may be disposed in a different sub-pixel column.

In embodiments, the pattern data may include a plurality of sub-data applied to the target sub-pixel row, each of the sub-data may include first data having a black gradation and second data having the grey gradation, the first data may be applied to sub-pixels other than the target sub-pixel among the sub-pixels included in the target sub-pixel row, and the second data may be applied to the target sub-pixel among the sub-pixels included in the target sub-pixel row.

In embodiments, the first to third selection signals may be applied during the second interval, and the reset signal may be applied before the third interval.

An electronic device according to embodiments of the disclosure includes a display panel including a plurality of blocks, where each of the blocks includes a plurality of sub-pixels, a data driver which supplies a data signal to the blocks via a plurality of data lines, a gate driver which supplies sub-gate signals to the sub-pixels, an emission driver which supplies light-emitting control signals to the plurality of sub-pixels, and a sensing unit connected to a first block among the blocks via a sensing line, where the sensing unit includes a sensing capacitor, where each of the sub-pixels includes a first transistor connected between a first power supply voltage node and a first node, where the first transistor includes a gate electrode connected to a second node, a second transistor connected between the second node and a data line, where the second transistor is turned on based on a first sub-gate signal among the sub-gate signals, a third transistor connected between the first power supply voltage node and the first transistor, where the third transistor is turned on based on a light-emitting control signal, a fourth transistor connected between the first node and the sensing line, where the fourth transistor is turned on based on a second sub-gate signal among the sub-gate signals, a storage capacitor connected between the first node and the second node, and a light-emitting element connected between the first node and a second power supply voltage node, the sensing line includes a first sub-sensing line connected to sub-pixels which emit light in a first color among sub-pixels included in the first block, and a second sub-sensing line connected to sub-pixels which emit light in a second color different from the first color among the sub-pixels included in the first block, and a first initialization voltage applied to the first sub-sensing line and a second initialization voltage applied to the second sub-sensing line may be different from each other.

In embodiments, the sensing line may further include a third sub-sensing line connected to sub-pixels which emit light in a third color different from the first color and the second color among the sub-pixels included in the first block, and a third initialization voltage applied to the third sub-sensing line, the first initialization voltage, and the second initialization voltage may be different from each other.

In embodiments, a blank interval of a frame may include a first interval, a second interval, and a third interval, a data signal corresponding to pattern data may be applied to sub-pixels included in a target sub-pixel row including a target sub-pixel during the first interval, the target sub-pixel may generate a driving current based on the pattern data and the sensing unit may generate sensing data based on the driving current, during the second interval after the first interval, and data signals corresponding to image data included in an active interval of a current frame may be applied to the sub-pixels included in the target sub-pixel row.

In embodiments, the target sub-pixel may generate the driving current based on a data signal corresponding to data having a grey gradation in the pattern data.

In embodiments, the sensing data may include the electrical characteristics of the target sub-pixel.

In embodiments, in one frame, the target sub-pixel of each of the blocks may be disposed in a different sub-pixel column.

In embodiments, the pattern data may include a plurality of sub-data applied to the target sub-pixel row, each of the sub-data may include first data having a black gradation and second data having the grey gradation, the first data may be applied to sub-pixels other than the target sub-pixel among the sub-pixels included in the target sub-pixel row, and the second data may be applied to the target sub-pixel among the sub-pixels included in the target sub-pixel row.

In embodiments, the first sub-gate signal may have a turn-on level and a data signal corresponding to the pattern data may be applied to the data line during the first interval, the second sub-gate signal and the light-emitting control signal may have turn-on levels during the second interval, and the first sub-gate signal may have a turn-on level during the third interval, and a data signal corresponding to image data included in an active interval of a current frame may be applied to the data line.

A sensing unit according to embodiments of the disclosure is connected to a block, which includes a plurality of sub-pixels, via a sensing line, and an operation method of the sensing unit includes applying first to third initialization voltages to the sub-pixels via the sensing line during an active interval of a frame, and generating sensing data including electrical characteristics of a target sub-pixel among sub-pixels connected via the sensing line during a blank interval of the frame, where the first initialization voltage applied to sub-pixels which emit light in a first color among the plurality of sub-pixels, the second initialization voltage applied to sub-pixels which emit light in a second color different from the first color among the plurality of sub-pixels, and the third initialization voltage applied to sub-pixels which emit light in a third color different from the first color and the second color among the plurality of sub-pixels may be different from each other.

According to embodiments of a display device of the disclosure, the display device may more accurately sense the electrical characteristics of pixels changed due to an external temperature.

### BRIEF DESCRIPTION OF THE DRAWINGS

FIG. 1 is a block diagram illustrating an embodiment of a display device.

FIG. 2 is a block diagram illustrating an embodiment of one of the sub-pixels of FIG. 1.

FIG. 3 is a circuit diagram illustrating an embodiment of the sub-pixels of FIG. 2.

FIG. 4 is a schematic diagram illustrating the operation of the display device of FIG. 1.

FIG. 5 is a block diagram illustrating the structure in which a data driver, a display panel, and a sensing driver of FIG. 1 are connected.

FIG. 6 is a block diagram illustrating the structure in which sub-pixels and a sensing driver are connected.

FIG. 7 is a block diagram illustrating an embodiment of a sensing driver.

FIG. 8 is a circuit diagram illustrating an embodiment of a first sensing unit.

FIG. 9 is a diagram illustrating the structure in which a first sub-pixel and a first sensing unit are connected.

FIG. 10 is a block diagram illustrating another embodiment of a first sensing unit.

FIG. 11 is a flowchart illustrating an embodiment of a sensing operation of the display device of FIG. 1.

FIG. 12 is a schematic diagram illustrating an operation of moving to a target line.

FIG. 13 is a signal timing diagram illustrating an example of driving a sub-pixel included in a target line during a blank interval.

FIG. 14 is a diagram illustrating an embodiment of pattern data.

FIG. 15 is a diagram illustrating another embodiment of pattern data.

FIG. 16 is a block diagram illustrating an electronic device according to embodiments of the disclosure.

FIG. 17 is a diagram illustrating an embodiment of the electronic device of FIG. 16 implemented as a smartphone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

Throughout the specification, when it is described that a part is “connected” to another part, it includes not only the case where they are “directly connected”, but also the case where they are “indirectly connected” with another element interposed therebetween.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. “At least one of X, Y, and Z” and “at least one selected from X, Y, and Z” may be interpreted as one X, one Y, one Z, or any combination of two or more of X, Y, and Z (e.g., XYZ, XYY, YZ, ZZ). It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

In addition, the terms “unit”, “module” and other terms used herein or the functional blocks illustrated in the drawings may be implemented in the form of software, hardware, or combinations thereof. In order to clarify the technical idea of this disclosure, a detailed description of the redundant components is omitted.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

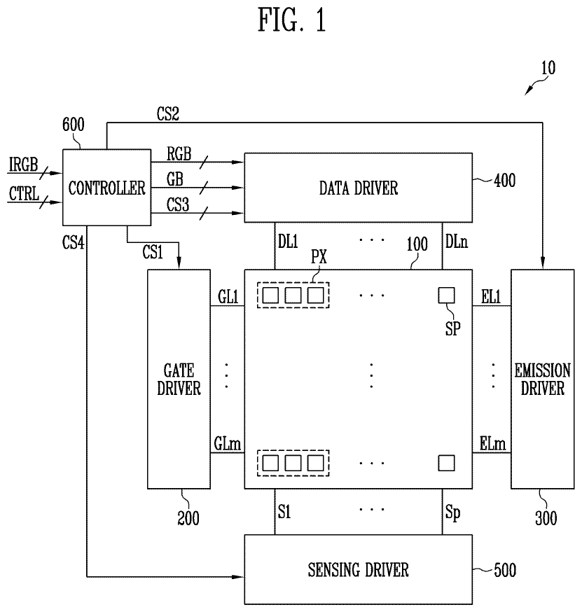

FIG. 1 is a block diagram illustrating an embodiment of a display device.

Referring to FIG. 1, an embodiment of a display device 10 may include a display panel 100, a gate driver 200, an emission driver 300, a data driver 400, a sensing driver (sensing unit) 500, and a controller 600.

The display panel 100 includes sub-pixels (SPs). The sub-pixels (SPs) may be connected to the gate driver 200 via first to m^{th} gate lines (GL1 to GLm) (herein, m is a natural number). The sub-pixels (SPs) may be connected to the data driver 400 via first to nth data lines (DL1 to DLn) (herein, n is a natural number).

Each of the sub-pixels (SPs) may include at least one light-emitting element that is configured to generate light. Accordingly, each sub-pixel (SP) may generate light in a specific color, such as red, green, blue, cyan, magenta, yellow, or the like. Two or more sub-pixels among sub-pixels (SPs) may constitute a single pixel (PX). In an embodiment, for example, as illustrated in FIG. 1, three sub-pixels may constitute or collectively define one pixel (PX).

The gate driver 200 is connected to sub-pixels (SPs) arranged in a row direction via the first to m^{th} gate lines (GL1 to GLm). The gate driver 200 may output gate signals to first to m^{th} gate lines (GL1 to GLm) in response to the first control signal (CS1).

The gate driver 200 may sequentially supply gate signals to the first to m^{th} gate lines (GL1 to GLm). When gate signals are supplied sequentially to the first to m^{th} gate lines (GL1 to GLm), sub-pixels (SPs) may be selected in units of horizontal lines (e.g., sub-pixel rows).

In embodiments, a first control signal (CS1) may include a start signal to indicate the start of each frame, a horizontal synchronization signal to output gate signals synchronously at the timing of the data signals being applied, and so on.

The emission driver 300 may be connected to sub-pixels (SPs) arranged in the row direction via first to m^{th} light-emitting control lines (EL1 to ELm). The emission driver 300 may output light-emitting control signals to the first to m^{th} light-emitting control lines (EL1 to ELm) in response to a second control signal (CS2).

In an embodiment, for example, the gate driver 200 and the emission driver 300 may be disposed on one side of the display panel 100. However, embodiments are not limited thereto. In another embodiment, for example, the gate driver 200 and the emission driver 300 may each be distinguished by two or more physically and/or logically distinct drivers, and such drivers may be disposed on one side of the display panel 100 and on the other side of the display panel 100 as opposed to the other. Thus, the gate driver 200 and the emission driver 300 may be disposed around the display panel 100 in various forms in embodiments.

The data driver 400 is connected to sub-pixels (SPs) arranged in the column direction via first to nth data lines (DL1 to DLn). The data driver 400 receives image data (RGB), pattern data (GB), and a third control signal (CS3) from the controller 600.

The data driver 400 operates in response to a third control signal (CS3). In embodiments, the third control signal (CS3) may include a source start pulse, a source shift clock, a source output enabling signal, and so on.

The data driver 400 may use voltages obtained from a voltage generator to apply data signals with graded (or grayscale) voltages corresponding to image data (RGB) to the first to n^{th} data lines 1 to 1 (DL1 to DLn).

With respect to the sub-pixels (SPs) selected by applying a gate signal to each of the first to m^{th} gate lines (GL1 to GLm), the data signals corresponding to the image data (RGB) may be applied to the data lines (DL1 to DLm). Accordingly, the sub-pixels (SPs) may generate light corresponding to the data signals. Accordingly, an image is displayed on the display panel 100.

In addition, the data driver 400 may use the voltages obtained from the voltage generator to apply data signals with gradation voltages corresponding to the pattern data (GB) to the first to nth data lines (DL1 to DLn). The pattern data may be data with a black gradation and a grey gradation.

With respect to the sub-pixels (SPs) selected by applying a gate signal to each of the first to m^{th} gate lines (GL1 to GLm), the data signal corresponding to the pattern data (GB) may be applied to the data lines (DL1 to DLm). Accordingly, the sub-pixels (SPs) may not generate light with a predetermined brightness.

In embodiments, sub-pixels (SPs) may not generate a driving current based on a data signal corresponding to a black gradation. The data signal corresponding to the black gradation may have the lowest voltage that the data signals applied to the data lines (DL1 to DLm) may have.

The sub-pixels (SPs) may generate a predetermined drive current based on a data signal corresponding to a grey gradation. That is, by applying a data signal corresponding to the grey gradation, sub-pixels to generate sensing data may be determined.

In embodiments, the gate driver 200, the emission driver 300, and the data driver 400 may include complementary metal-oxide semiconductor (CMOS) circuit elements.

The sensing driver 500 may supply an initialization voltage to sensing lines (S1 to Sp) (herein, p is a natural number less than or equal to n) or may generate sensing data of the sub-pixels (SPs) connected to the sensing lines (S1 to Sp).

The sensing data may include the electrical characteristics of the sub-pixels (SPs) connected to the sensing lines (S1 to Sp). In an embodiment, for example, the sensing data may include information associated with the threshold voltage of a driving transistor which is changed due to the external temperature of the display device 10.

During an active interval, the sensing driver 500 may supply an initialization voltage to the sensing lines (S1 to Sp). The active interval is the period during which sub-pixels (SPs) generate light of a predetermined brightness based on a data signal supplied from the data driver 400. During the active interval, the data signal supplied from the data driver 400 may correspond to the image data (RGB).

During a blank interval, the sensing driver 500 may generate sensing data of the sub-pixels (SPs) connected to the sensing lines (S1 to Sp). The blank interval is the period during which sub-pixels (SPs) generate a sensing current in response to the data signal supplied from the data driver 400. The data signal supplied from the data driver 400 during the blank interval may correspond to the pattern data (GB).

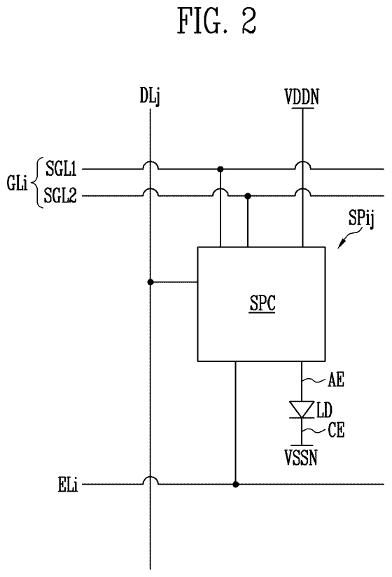

The sensing driver 500 may generate sensing data based on a sensing current. The sensing current may be a driving current flowing via the light-emitting elements (LD in FIG. 2) of sub-pixels (SPs) during the blank interval. More detailed features of the active and blank intervals will be described later with reference to FIG. 4.

In respond to a fourth control signal (CS4), the sensing driver 500 may supply an initialization voltage to sub-pixels (SPs) or may generate sensing data of the sub-pixels (SPs).

In embodiments, the display device 10 may further include a voltage generator (not shown). The voltage generator may operate in response to a voltage control signal from the controller 600. The voltage generator may be configured to generate a plurality of voltages and to provide the generated voltages to the components of the display device 10. In an embodiment, for example, the voltage generator may be configured to receive an input voltage from the outside of the display device 10, adjust the received voltage, and regulate the adjusted voltage, to generate a plurality of voltages.

In an embodiment, for example, the voltage generator may generate a first power supply voltage, and a second power supply voltage. The first power supply voltage may have a relatively high voltage level, and the second power supply voltage may have a lower voltage level than the first power supply voltage. In other embodiments, the first power supply voltage or the second power supply voltage may be provided by an external device of the display device 10.

In addition, the voltage generator may generate various voltages. In an embodiment, for example, the voltage generator may generate an initialization voltage that is applied to sub-pixels (SPs).

The controller 600 controls the overall operation of the display device 10. The controller 600 receives, from the outside, input image data (IRGB) and a control signal (CTRL) to control its display. In respond to a control signal (CTRL), the controller 600 may provide first to fourth control signals (CS1 to CS4).

The controller 600 may convert the input image data (IRGB) to be suitable for the display device 10 or the display panel 100, and may output image data (RGB). In the embodiments, the controller 600 may align the input image data (IRGB) to be suitable for the sub-pixels (SPs) in units of rows and may output image data (RGB).

In addition, the controller 600 may output pattern data (GB) for the generation of sensing data to the data driver 400.

FIG. 2 is a block diagram illustrating an embodiment of one of the sub-pixels of FIG. 1. In FIG. 2, a sub-pixel (SPij) arranged in an i^{th} row (herein, i is greater than or equal to 1 and less than or equal to m) and a j^{th} column (herein, j is greater than or equal to 1 and less than or equal to n) among the sub-pixels (SPs) of FIG. 1 is illustrated for convenience of illustration and description.

Referring to FIG. 2, an embodiment of the sub-pixel (SPij) may include a sub-pixel circuit (SPC) and a light-emitting element (LD).

In an embodiment, the light-emitting element (LD) is connected between a first power supply voltage node (VDDN) and a second power supply voltage node (VSSN). In such an embodiment, the first power supply voltage node (VDDN) is a node that transfers a first power supply voltage, and the second power supply voltage node (VSSN) is a node that transfers a second power supply voltage.

An anode electrode (AE) of the light-emitting element (LD) may be connected to the first power supply voltage node (VDDN) via a sub-pixel circuit (SPC), and a cathode electrode (CE) of the light-emitting element (LD) may be connected to the second power supply voltage node (VSSN). In an embodiment, for example, the anode electrode (AE) of the light-emitting element (LD) may be connected to the first power supply voltage node (VDDN) via one or more transistors included in the sub-pixel circuit (SPC).

The sub-pixel circuit (SPC) may be connected to an i^{th} gate line (GLi) among the first to m^{th} gate lines (GL1 to GLm) of FIG. 1, an i^{th} light-emitting control line (ELi) among the first to m^{th} light-emitting control lines (EL1 to ELm) of FIG. 1, and a j^{th} data line (DLj) among the first to n^{th} data lines (DL1 to DLn) of FIG. 1. The sub-pixel circuit (SPC) is configured to control the light-emitting element (LD) based on signals applied thereto via the signal lines.

The sub-pixel circuit (SPC) may operate in response to a gate signal applied thereto via the i^{th} gate line (GLi). The i^{th} gate line (GLi) may include one or more sub-gate lines. In the embodiments, as illustrated in FIG. 2, the i^{th} gate line (GLi) may include first and second sub-gate lines (SGL1, SGL2). The sub-pixel circuit (SPC) may operate in response to gate signals applied thereto via the first and second sub-gate lines (SGL1, SGL2). As describe above, if the i^{th} gate line (GLi) includes two or more sub-gate lines, the sub-pixel circuit (SPC) may operate in response to gate signals applied thereto via the corresponding sub-gate lines.

The sub-pixel circuit (SPC) may operate in response to a light-emitting control signal applied thereto via the i^{th} light-emitting control line (ELi). In embodiments, the i^{th} light-emitting control line (ELi) may include one or more sub-light-emitting control lines. If the i^{th} light-emitting control line (ELi) includes two or more sub-light-emitting control lines, the sub-pixel circuit (SPC) may operate in response to the light-emitting control signals applied thereto via the corresponding sub-light-emitting control lines.

The sub-pixel circuit (SPC) may receive data signals via the j^{th} data line (DLj). In response to at least one of the gate signals applied thereto via the first and second sub-gate lines (SGL1, SGL2), the sub-pixel circuit (SPC) may store a voltage corresponding to the data signal. In response to a light-emitting control signal applied thereto via the i^{th} light-emitting control line (ELi), the sub-pixel circuit (SPC) may adjust, according to a stored voltage, a driving current flowing from the first power supply voltage node (VDDN) to the second power supply voltage node (VSSN) via the light-emitting element (LD). Accordingly, the light-emitting element (LD) may generate light with a brightness corresponding to the data signal.

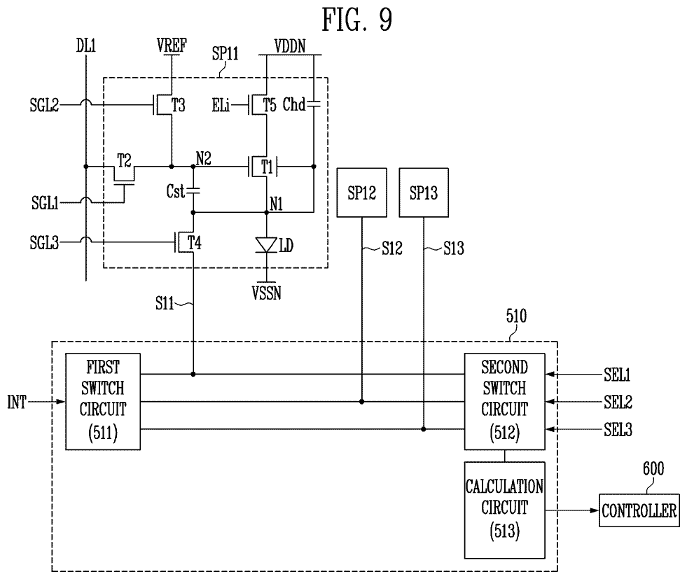

Although a sensing line is not illustrated in FIG. 2, the connection relationship between the sub-pixel (SPij) and the sensing line will be described later with reference to FIG. 9.

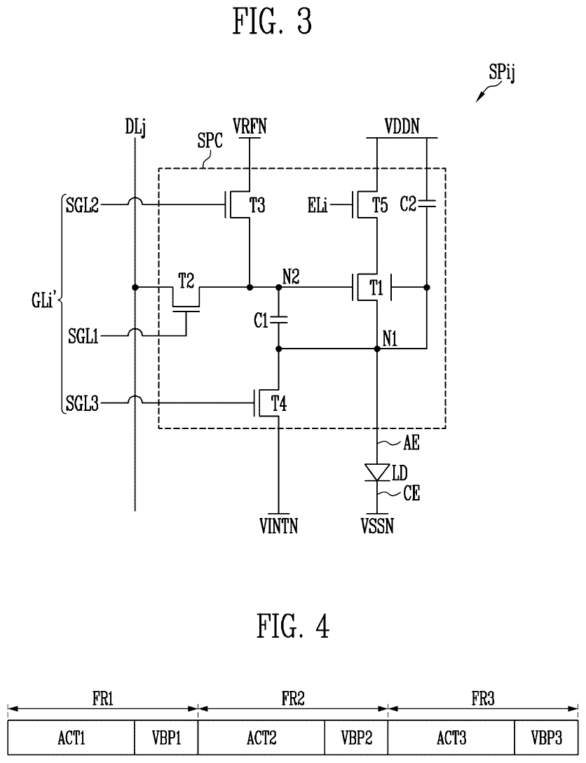

FIG. 3 is a circuit diagram illustrating an embodiment of the sub-pixel of FIG. 2.

Referring to FIG. 3, an embodiment of a sub-pixel (SPij) may include a sub-pixel circuit (SPC) and a light-emitting element (LD).

The sub-pixel circuit (SPC) may be connected to an i^{th} gate line (GLi′), an i^{th} light-emitting control line (ELi), and a j^{th} data line (DLj). Compared with the i^{th} line (GLi) of FIG. 2, the i^{th} gate line (GLi′) may further include a third sub gate line (SGL3).

The sub-pixel circuit (SPC) may include first to fifth transistors (T1 to T5), and first and second capacitors (C1, C2).

The first transistor (T1) is connected between the first power supply voltage node (VDDN) and a first node (N1). A gate electrode of the first transistor (T1) is connected to a second node (N2), such that the first transistor (T1) may be turned on based on a voltage level of the second node (N2). The first transistor (T1) may be referred to as a driving transistor. The first node (N1) may be an anode electrode (AE) of the light-emitting element (LD). In addition, the first node (N1) may be connected to a body electrode of the first transistor (T1).

The second transistor (T2) is connected between the j^{th} data line (DLj) and the second node (N2). A gate electrode of the second transistor (T2) is connected to a first sub-gate line (SGL1), such that the second transistor (T2) may be turned on in response to a gate signal of the first sub-gate line (SGL1). The second transistor (T2) may be referred to as a switching transistor.

The third transistor (T3) is connected between a reference voltage node (VRFN) and the second node (N2). The gate electrode of the third transistor (T3) is connected to a second sub-gate line (SGL2), such that the third transistor (T3) may be turned on in response to a gate signal of the second sub-gate line (SGL2). The reference voltage node (VRFN) is a node that transfers a reference voltage, which may be less than the first power supply voltage and greater than the second power supply voltage.

The fourth transistor (T4) is connected between the first node (N1) and an initialization voltage node (VINTN). A gate electrode of the fourth transistor (T4) is connected to the third sub-gate line (SGL3), such that the fourth transistor (T4) may be turned on in response to a gate signal of the third sub-gate line (SGL3). The initialization voltage node (VINTN) is a node that transfers an initialization voltage, which may be less than the first power supply voltage and greater than the second power supply voltage. In addition, the initialization voltage may be less than the reference voltage.

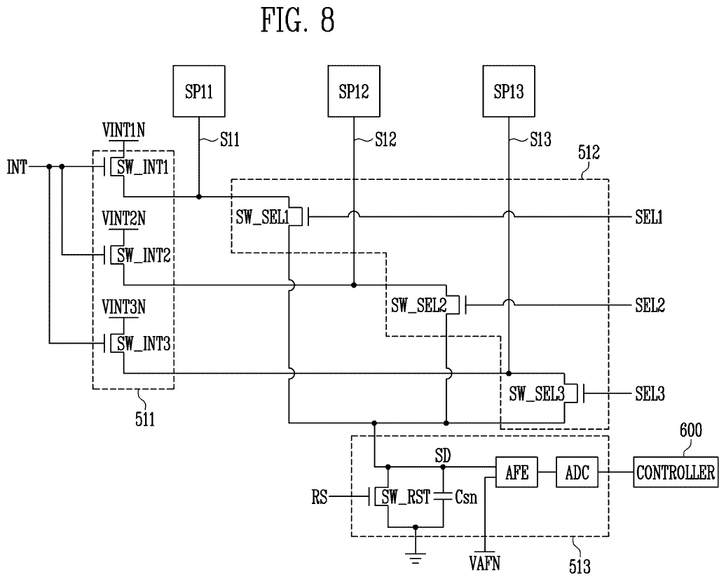

In embodiments, the initialization voltage node (VINTN) may be connected to the first to p^{th} sensing lines (S1 to Sp) of FIG. 1. A detailed description thereof will be given later with reference to FIG. 8.

The fifth transistor (T5) is connected between the first power supply voltage node (VDDN) and the first transistor (T1). A gate electrode of the fifth transistor (T6) is connected to the i^{th} light-emitting control line (ELi), such that the fifth transistor (T5) may be turned on in response to a light-emitting control signal of the i^{th} light-emitting control line (ELi).

The first capacitor C1 is connected between the first node (N1) and the second node (N2). The second capacitor (C2) is connected between the first power supply voltage node (VDDN) and the first node (N1).

As described above, the sub-pixel circuit (SPC) may include the first to fifth transistors (T1 to T5), and the first and second capacitors (C1, C2). However, embodiments are not limited thereto. The sub-pixel circuit (SPC) may be embodied in one of the various types of circuits that include a plurality of transistors and one or more capacitors. In an embodiment, for example, the sub-pixel circuit (SPC) may include two transistors and one capacitor. In embodiments of the sub-pixel circuit (SPC), the number of sub-gate lines included in the i^{th} gate line (GLi′) may vary.

In an embodiment, the first to fifth transistors (T1 to T5) may be N-type transistors. Each of the first to fifth transistors (T1 to T5) may be a metal oxide silicon field effect transistor (MOSFET) including a body electrode. In such an embodiment, a turn-off level may be a low voltage level, and a turn-on level may be a high voltage level. In an embodiment, for example, when a signal applied to a control electrode of an N-type transistor has a low voltage level, the N-type transistor may be turned off. In an embodiment, for example, when a signal applied to the control electrode of the N-type transistor has a high voltage level, the N-type transistor may be turned on.

However, embodiments are not limited thereto. In an embodiment, for example, at least one of the first to fifth transistors (T1 to T5) may be replaced with a P-type transistor. In such an embodiment, a turn-on level may be a low voltage level, and a turn-off level may be a high voltage level. In an embodiment, for example, when a signal applied to a control electrode of a P-type transistor has a low voltage level, the P-type transistor may be turned on. In an embodiment, for example, when a signal applied to the control electrode of the P-type transistor has a high voltage level, the P-type transistor may be turned off.

In embodiments, the first to fifth transistors (T1 to T5) may include amorphous silicon semiconductors, monocrystalline silicon, polycrystalline silicon semiconductors, oxide semiconductors, or the like.

The light-emitting element (LD) may include an anode electrode (AE), a cathode electrode (CE), and a light-emitting layer. The light-emitting layer may be disposed between the anode electrode (AE) and the cathode electrode (CE). After a data signal transmitted via the j^{th} data line (DLj) is applied to a voltage of the second node (N2), when light-emitting control signals of the i^{th} light-emitting control lines (ELi) are enabled to a higher voltage level, the fifth transistor T5 may be turned on. In addition, the first transistor (T1) may be turned on based on a voltage of the second node (N2), such that current may flow from the first power supply voltage node (VDDN) to the second power supply voltage node (VSSN). The light-emitting element (LD) may emit light depending on the amount of flowing driving current.

FIG. 4 is a schematic diagram illustrating the operation of the display device of FIG. 1.

Referring to FIG. 4, a first frame (FR1) may include a first active interval (ACT1) and a first blank interval (VBP1), a second frame (FR2) may include a second active interval (ACT2) and a second blank interval (VBP2), and a third frame (FR3) may include a third active interval (ACT3) and a third blank interval (VBP3).

The display device 10 of FIG. 1 may be operated on a frame-by-frame basis.

During the active intervals (ACT1, ACT2, ACT3), the data driver 400 may apply data signals having graded voltages corresponding to image data (RGB) to first to nth data lines (DL1 to DLn) with respect to sub-pixels (SPs). Accordingly, the display panel 100 may emit light in response to the image data (RGB) during the active intervals.

During the blank intervals (VBP1, VBP2, VBP3), sensing driver 500 may generate sensing data by sensing some of the sub-pixels (SPs). In an embodiment, for example, in the blank intervals (VBP1, VBP2, VBP3), sensing driver 500 may generate sensing data by sensing sub-pixels.

Referring to FIG. 4, the first to third frames (FR1 to FR3) are illustrated, but this disclosure is not limited thereto, and the display device 10 may be operated during three or more frames.

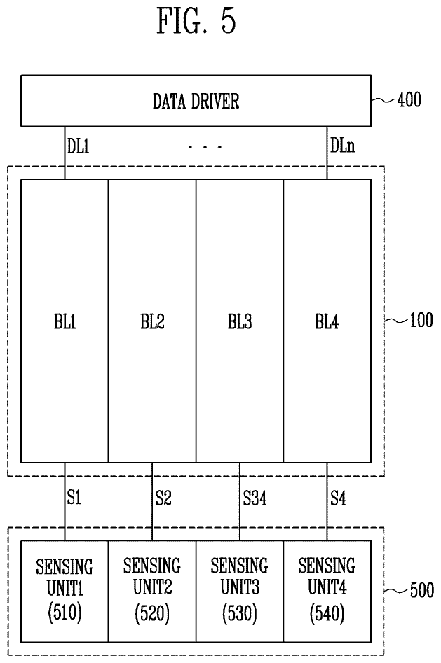

FIG. 5 is a block diagram illustrating the structure in which a data driver, a display panel, and a sensing driver in FIG. 1 are connected.

Referring to FIG. 5, an embodiment of the display panel 100 may include first to fourth blocks (BL1 to BL4), and the sensing driver 500 may include first to fourth sensing units 510 to 540.

Each of the first to fourth blocks (BL1 to BL4) may include a plurality of sub-pixels (SPs). Referring to FIG. 1, each of the first to fourth blocks (BL1 to BL4) may include sub-pixels (SPs) arranged in the column direction. Each of the first to fourth blocks (BL1 to BI4) may include k sub-pixel columns (herein, k is a natural number less than or equal to n). In an embodiment, for example, each of the first to fourth blocks (BL1 to BI4) may include 6 sub-pixel columns.

The first to fourth blocks (BL1 to BL4) may be connected to the first to fourth sensing units 510 to 540, respectively. The first block (BL1) may be connected to the first sensing unit 510 via the first sensing line (S1), the second block (BL2) may be connected to the second sensing unit 520 via the second sensing line (S2), the third block (BL3) may be connected to the third sensing unit 530 via the third sensing line (S3), and the fourth block (BL4) may be connected to the fourth sensing unit 540 via the fourth sensing line (S4).

The first to fourth sensing units 510 to 540 may generate sensing data of the connected blocks, respectively.

Although an embodiment where the display panel 100 includes the first to fourth blocks (BL1 to BL4) and the sensing driver 500 includes the first to fourth sensing units 510 to 540 is shown in FIG. 5 for convenience of illustration and description, this disclosure is not limited thereto, and the display panel 100 may include four or more blocks and the sensing driver 500 may include four or more sensing units.

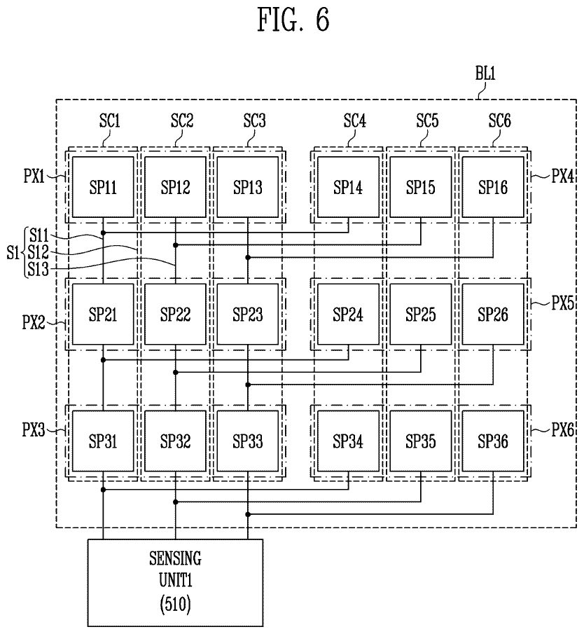

FIG. 6 is a block diagram illustrating the structure in which sub-pixels and sensing drivers are connected.

Referring to FIGS. 5 and 6, a connection structure of the first block (BL1) and the first sensing unit 510 is shown.

In an embodiment, the first block (BL1) may include first to sixth sub-pixel columns (SC1 to SC6). The first sub-pixel column (SC1) may include sub-pixels (SP11, SP21,

SP31), the second sub-pixel column (SC2) may include sub-pixels (SP12, SP22, SP32), the third sub-pixel column (SC3) may include sub-pixels (SP13, SP23, SP33), the fourth sub-pixel column (SC4) may include sub-pixels (SP14, SP24, SP34), the fifth sub-pixel column (SC5) may include sub-pixels (SP15, SP25, SP35), and the sixth sub-pixel column (SC6) may include sub-pixels (SP16, SP26, SP36).

Sub-pixels disposed in a same sub-pixel row among the first to third sub-pixel columns (SC1 to SC3) may constitute one pixel.

In an embodiment, for example, a first pixel (PX1) may include the sub-pixel (SP11) disposed in a first sub-pixel row of the first sub-pixel column (SC1), the sub-pixel (SP12) disposed in the first sub-pixel row of the second sub-pixel column (SC2), and the sub-pixel (SP13) disposed in the first sub-pixel row of the third sub-pixel column (SC3).

In such an embodiment, a second pixel (PX2) may include the sub-pixel (SP21) disposed in a second sub-pixel row of the first sub-pixel column (SC1), the sub-pixel (SP22) disposed in the second sub-pixel row of the second sub-pixel column (SC2), and the sub-pixel (SP23) disposed in the second sub-pixel row of the third sub-pixel column (SC3).

In such an embodiment, a third pixel (PX3) may include the sub-pixel (SP31) disposed in a third sub-pixel row of the first sub-pixel column (SC1), the sub-pixel (SP32) disposed in the third sub-pixel row of the second sub-pixel column (SC2), and the sub-pixel (SP33) disposed in the third sub-pixel row of the third sub-pixel column (SC3).

In addition, sub-pixels disposed in the same sub-pixel row among the fourth to sixth sub-pixel columns (SC4 to SC6) may constitute one pixel.

In an embodiment, for example, a fourth pixel (PX4) may include the sub-pixel (SP14) disposed in the first sub-pixel row of the fourth sub-pixel column (SC4), the sub-pixel (SP15) disposed in the first sub-pixel row of the fifth sub-pixel column (SC5), and the sub-pixel (SP16) disposed in the first sub-pixel row of the sixth sub-pixel column (SC6).

In such an embodiment, a fifth pixel (PX5) may include the sub-pixel (SP24) disposed in the second sub-pixel row of the fourth sub-pixel column (SC4), the sub-pixel (SP25) disposed in the second sub-pixel row of the fifth sub-pixel column (SC5), and the sub-pixel (SP26) disposed in the second sub-pixel row of the sixth sub-pixel column (SC6).

In such an embodiment, a sixth pixel (PX6) may include the sub-pixel (SP34) disposed in the third sub-pixel row of the fourth sub-pixel column (SC4), the sub-pixel (SP35) disposed in the third sub-pixel row of the fifth sub-pixel column (SC5), and the sub-pixel (SP36) disposed in the third sub-pixel row of the sixth sub-pixel column (SC6).

In embodiments, a first sensing line (S1) may include a first sub-sensing line S11, a second sub-sensing line S12, and a third sub-sensing line S13.

The first sub-sensing line S11 may be connected to the sub-pixel columns that emit light in a first color among the sub-pixel columns of the first block (BL1), and the second sub-sensing line (S12) may be connected to the sub-pixel columns that emit light in a second color among the sub-pixel columns of the first block (BL1), and the third sub-sensing line (S13) may be connected to the sub-pixel columns that emit light in a third color among the sub-pixel columns of the first block (BL1).

In an embodiment, for example, the first sub-sensing line (S11) may be connected to the first sub-pixel column (SC1) and the fourth sub-pixel column (SC4), the second sub-sensing line (S12) may be connected to the second sub-pixel column (SC2) and the fifth sub-pixel column (SC5), and the third sub-sensing line (S13) may be connected to the third sub-pixel column (SC3) and the sixth sub-pixel column (SC6).

The first to third sub-sensing lines (S11 to S13) may be connected to all of the pixels included in the connected sub-pixel columns.

In an embodiment, for example, the first sub-sensing line (S11) may be connected to the pixels (SC11, SP21, SP31) of the first sub-pixel column (SC1) and the pixels (SP14, SP24, SP34) of the fourth sub-pixel column (SC4).

The second sub-sensing line (S12) may be connected to the pixels (SP12, SP22, SP32) of the second sub-pixel column (SC2) and the pixels (SP15, SP25, SP35) of the fifth sub-pixel column (SC5).

The third sub-sensing line (S13) may be connected to the pixels (SP13, SP23, SP33) of the third sub-pixel column (SC3) and the pixels (SP16, SP26, SP36) of the sixth sub-pixel column (SC6).

Accordingly, the first sensing unit 510 may be connected to all of the sub-pixels (SP11 to SP36) included in the first block (BL1) via the first sensing line (S1). In addition, the first sensing unit 510 may generate sensing data of the sub-pixels (SP11 to SP13) included in the first block (BL1), via the first sensing line (S1).

Although an embodiment where the first block (BL1) includes six sub-pixel columns and three sub-pixel rows is shown in FIG. 6 for convenience of illustration and description, this disclosure is not limited thereto, and the first block (BL1) may include six or more sub-pixel columns and three or more sub-pixel rows.

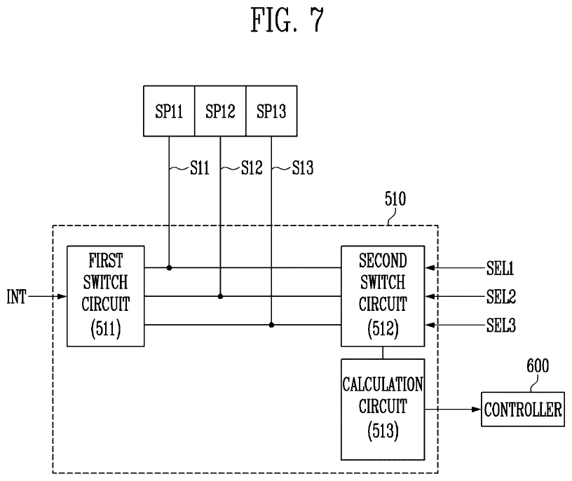

FIG. 7 is a block diagram illustrating an embodiment of a sensing driver.

Referring to FIG. 7, an embodiment of the first sensing unit 510 may include a first switch circuit 511, a second switch circuit 512, and a calculation circuit 513.

In FIG. 7, the first to third sub-pixels (SP11, SP12, SP13) of the sub-pixels included in the first block (BL1) of FIG. 6 are schematically illustrated for clarity and conciseness. Other sub-pixels included in the first block (BL1) may be connected to the first sensing unit 510, as may the first to third sub-pixels (SP11, SP12, SP13).

In embodiments, during an active interval, the controller 600 of FIG. 1 may output a voltage application signal (INT) to the sensing driver 500. The voltage application signal (INT) may be included in the fourth control signal (CS4) of FIG. 1.

The first switch circuit 511 may be connected between a voltage generator generating an initialization voltage and the sub-pixels connected to the first sensing unit 510.

The first switch circuit 511 may apply the initialization voltage to the sub-pixels connected to the first sensing unit 510 based on the voltage application signal (INT) applied thereto during the active interval.

In an embodiment, for example, the first switch circuit 511 may apply a first initialization voltage to the first sub-pixel (SP11) via the first sub-sensing line (S11).

The first switch circuit 511 may apply a second initialization voltage to the second sub-pixel (SP12) via the second sub-sensing line (S12).

The first switch circuit 511 may apply a third initialization voltage to the third sub-pixel (SP13) via the third sub-sensing line (S13).

In such an embodiment, the first to third initialization voltages may be the initialization voltages supplied to the sub-pixels via the initialization voltage node (VINTN) described in FIG. 3. A more detailed description thereof will be given later with reference to FIG. 8.

In embodiments, during a blank interval, the controller 600 of FIG. 1 may output one of first to third selection signals (SEL1 to SEL3) to the sensing driver 500. The first to third selection signals (SEL1 to SEL3) may be included in the fourth control signal (CS4) of FIG. 1.

The second switch circuit 512 may be connected between the sub-pixels connected to the first sensing unit 510 and the calculation circuit 513.

The second switch circuit 512 may select a target sub-pixel to sense among the sub-pixels included in a target line based on the first to third selection signals (SEL1 to SEL3) applied thereto during the blank interval. The sub-pixel selected by the second switch circuit 512 may be connected to the calculation circuit 513.

The target line may refer to a sub-pixel row including the target sub-pixel that is the target of a sensing operation. In embodiments, the target line may be selected by gate signals. The first to third sub-pixels (SP11 to SP13) may be included in the target line.

The second switch circuit 512 may select the first sub-pixel (SP11) based the first selection signal (SEL1), select the second sub-pixel (SP12) based on the second selection signal (SEL2), and select the third sub-pixel (SC13) based on the third selection signal (SEL3).

The calculation circuit 513 may generate sensing data of the sub-pixel selected by the second switch circuit 512.

FIG. 8 is a circuit diagram illustrating an embodiment of a first sensing unit. FIG. 9 is a diagram illustrating the structure in which a first sub-pixel and a first sensing unit.

Referring to FIGS. 8 and 9, an embodiment of the first switch circuit 511, the second switch circuit 512, and the calculation circuit 513, which are connected to first to third sub-pixels (SP11 to SP13), is illustrated.

In FIG. 9, the first sub-pixel (SP11) is schematically illustrated for clarity and conciseness. In such an embodiment, other sub-pixels included in a first block (BL1) may also be connected to the first sensing unit 510 as well as the first sub-pixel (SP11).

Referring to FIG. 9, a fourth transistor (T4) may be connected between a first node (N1) and a first sub-sensing line (S11). That is, the fourth transistor (T4) of each of the sub-pixels included in the first block (BL1) may be connected between a first node (N1) therein and a corresponding sensing line.

In an embodiment, as shown in FIG. 8, the first switch circuit 511 may include a first initialization switch (SW_INT1), a second initialization switch (SW_INT2), and a third initialization switch (SW_INT3).

The first initialization switch (SW_INT1) may be connected between a first initialization voltage node (VINT1N) to which the first initialization voltage is applied and the first sub-sensing line (S11). When the first initialization switch (SW_INT1) is turned on in response to a voltage application signal (INT), the first initialization voltage may be applied to the first sub-sensing line (S11).

Accordingly, when the first initialization switch (SW_INT1) is turned on in response to the voltage application signal (INT) and the fourth transistor (T4) of the first sub-pixel (SP11) is turned on in response to a third sub-gate signal, the first initialization voltage may be applied to the first node (N1) of the first sub-pixel (SP11).

The second initialization switch (SW_INT2) may be connected between a second initialization voltage node (VINT2N) to which the second initialization voltage is applied and a second sub-sensing line (S12). When the second initialization switch (SW_INT2) is turned on in response to a voltage application signal (INT), a second initialization voltage may be applied to the second sub-sensing line (S12).

Accordingly, when the second initialization switch (SW_INT2) is turned on in response to a voltage application signal (INT), and the fourth transistor (T4) of the second sub-pixel (SP12) is turned on in response to a third sub-gate signal, the second initialization voltage may be applied to the first node (N1) of the second sub-pixel (SP12).

The third initialization switch (SW_INT3) may be connected between a third initialization voltage node (VINT3N) to which a third initialization voltage is applied and a third sub-sensing line (S13). When the third initialization switch (SW_INT3) is turned on in response to a voltage application signal (INT), the third initialization voltage may be applied to the third sub-sensing line (S13).

Accordingly, when the third initialization switch (SW_INT3) is turned on in response to a voltage application signal (INT), and the fourth transistor (T4) of the third sub-pixel (SP13) is turned on in response to a third sub-gate signal, the third initialization voltage may be applied to the first node (N1) of the third sub-pixel (SP13). The first and third initialization voltages may be different from each other.

In embodiments, where the first sub-pixel (SP11) emits light in red, the second sub-pixel (SP12) emits in blue, and the third sub-pixel (SP13) emits light in green, the first initialization voltage may be greater than the second initialization voltage, and the second initialization voltage may be greater than the third initialization voltage.

In an embodiment, as shown in FIG. 8, the second switch circuit 512 may include a first selection switch (SW_SEL1), a second selection switch (SW_SEL2), and a third selection switch (SW_SEL3).

The first selection switch (SW_SEL1) may be connected between the first sub-sensing line (S11) and a sensing node (SD). In response to a first selection signal (SEL1), the first selection switch (SW_SEL1) may connect the first sub-pixel (SP11) and the calculation circuit 513 via the first sub-sensing line (S11).

In an embodiment, when the first selection switch (SW_SEL1) is turned on in response to the first selection signal (SEL1), a first sensing current of the first sub-pixel (SP11) may be applied to the sensing node (SD) via the first sub-sensing line (S11). The first sensing current may correspond to a driving current that flows via a light-emitting element (LD) of the first sub-pixel (SP11) during the blank interval.

The second selection switch (SW_SEL2) may be connected between the second sub-sensing line (S12) and the sensing node (SD). In response to a second selection signal (SEL2), the second selection switch (SW_SEL2) may connect the second sub-pixel (SP12) and the calculation circuit 513 via the second sub-sensing line (S12).

In an embodiment, when the second selection switch (SW_SEL2) is turned on in response to the second selection signal (SEL2), a second sensing current of the second sub-pixel (SP12) may be applied to the sensing node (SD) via the second sub-sensing line (S12). The second sensing current may correspond to a driving current that flow via a light-emitting element (LD) of the second sub-pixel (SP12) during the blank interval.

The third selection switch (SW_SEL3) may be connected between the third sub-sensing line (S13) and the sensing node (SD). In response to a third selection signal (SEL3), the third selection switch (SW_SEL3) may connect the third sub-pixel (SP13) and the calculation circuit 513 via the third sub-sensing line (S13).

In an embodiment, when the third selection switch (SW_SEL3) is turned on in response to the third selection signal (SEL3), a third sensing current of the third sub-pixel (SP13) may be applied to the sensing node (SD) via the third sub-sensing line (S13). The third sensing current may correspond to a driving current that flows via a light-emitting element (LD) of the third sub-pixel (SP13) during the blank interval.

In an embodiment, the calculation circuit 513 may include a reset switch (SW_RST), a sensing capacitor (Csn), an analog front-end (AFE), and an analog-to-digital converter (ADC).

The reset switch (SW_RST) may be connected between the sensing node (SD) and a ground power supply. When the reset switch (SW_RST) is turned on in response to a reset signal (RS), a voltage of the ground power supply may be applied to the sensing node (SD).

The sensing capacitor (Csn) may be connected between the sensing node (SD) and the ground power supply. The sensing capacitor (Csn) may be charged by a current provided to the sensing node (SD) via the first sensing line.

At an input end of the analog front-end (AFE), the sensing node (SD) and a driving voltage node (VAFN) may be connected. The driving voltage node (VAFN) may be provided with a voltage used for operating the analog front-end (AFE).

When a sensing current of the first sub-pixel (SP11) is applied to the sensing node (SD), a first driving voltage may be applied to the driving voltage node (VAFN). In other words, when the first selection switch (SW_SEL1) is turned on, the first driving voltage may be applied to the driving voltage node (VAFN).

When a sensing current of the second sub-pixel (SP12) is applied to the sensing node (SD), a second driving voltage may be applied to the driving voltage node (VAFN). In other words, when the second selection switch (SW_SEL2) is turned on, the second driving voltage may be applied to the driving voltage node (VAFN).

When a sensing current of the third sub-pixel (SP13) is applied to the sensing node (SD), a third driving voltage may be applied to the driving voltage node (VAFN). In other words, when the third selection switch (SW_SEL3) is turned on, the third driving voltage may be applied to the driving voltage node (VAFN). The first to third driving voltages may be different from each other.

In embodiments, where the first sub-pixel (SP11) emits light in red, the second sub-pixel (SP12) emits light in blue, and the third sub-pixel (SP13) emits light in green, the first driving voltage may be greater than the second driving voltage, and the second driving voltage may be greater than the third driving voltage.

The analog front-end (AFE) may temporarily store the voltage stored at both ends of the sensing capacitor (Csn).

The analog-to-digital converter (ADC) may convert a voltage provided by the analog front-end (AFE) into a data value (e.g., a digital code). Accordingly, the calculation circuit 513 may generate sensing data of a pixel. The sensing data in a digital form may be provided to the controller 600.

The sensing data provided to the controller 600 may be utilized to compensate for a change in the electrical characteristics of the sub-pixels. In an embodiment, for example, the controller 600 may generate temperature data including a temperature change of the display device 10 due to an external environment, from the sensing data by referring to a lookup table. The lookup table may be stored in an internal memory of the display device 10, or may be stored in the controller 600.

The controller 600 may control various operations of the display device 10 based on the temperature data. In embodiments, the controller 600 may adjust the brightness of an image output to the display panel 100 based on temperature data. In an embodiment, for example, the controller 600 may adjust the data signals and the first and second supply voltages by controlling components such as the data driver 400 and/or the voltage generator.

Although the operation of the first sensing unit 510 based on the first sub-pixel (SP11) is described above with reference to FIGS. 8 and 9, the first sensing unit may operate with respect to other sub-pixels in a similar manner, and other sensing units may also operate similarly to the first sensing unit 510.

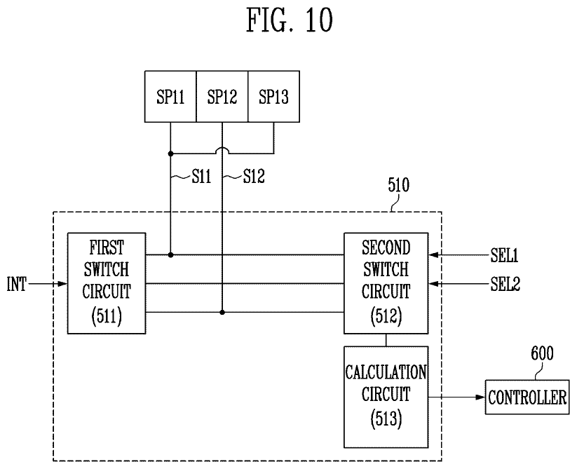

FIG. 10 is a block diagram illustrating another embodiment of a first sensing unit.

Referring to FIG. 10, an embodiment of the first sensing unit 510 may include the first switch circuit 511, the second switch circuit 512, and the calculation circuit 513.

The first sensing unit 510 of FIG. 10 is substantially the same as the first sensing unit 510 of FIG. 7, and thus any repetitive detailed descriptions thereof will be omitted.

During an active interval, the first switch circuit 511 may apply an initialization voltage to sub-pixels connected to the first sensing unit 510 based on a voltage application signal (INT).

In an embodiment, for example, the first switch circuit 511 may apply a first initialization voltage to a first sub-pixel (SP11) and a third sub-pixel (SP13) via a first sub-sensing line S11.

The first switch circuit 511 may apply a second initialization voltage to a second sub-pixel (SP12) via a second sub-sensing line (S12). In such an embodiment, the first and second initialization voltages may be initialization voltages supplied to sub-pixels via the initialization voltage node (VINTN) as described above with reference to FIG. 3.

In an embodiment, as shown in FIG. 10, an initialization voltage may be applied to sub-pixel columns to which a same initialization voltage is applied by the first switch circuit 511 via a same sub-sensing line.

Based on first and second selection signals (SEL1, SEL2) applied thereto during a blank interval, the second switch circuit 512 may select a sub-pixel to sense among the sub-pixels included in a target line. The sub-pixel selected by the second switch circuit 512 may be connected to the calculation circuit 513.

In an embodiment, for example, the second switch circuit 512 may select the first sub-pixel (SP11) and the third sub-pixel (SP13) based on the first selection signal (SEL1), and may select the second sub-pixel (SP12) based on the second selection signal (SEL2).

In an embodiment, as shown in FIG. 10, the second switch circuit 512 may select sub-pixel columns to which a same initialization voltage is applied based on a same selection signal.

Although FIG. 10 shows an embodiment where the first sub-pixel (SP11) and the third sub-pixel (SP13) are controlled by the same sub-sensing line, this disclosure is not limited thereto, and the first sub-pixel (SP11) and the second sub-pixel (SP12) may be controlled by a same sub-sensing line. In another embodiment, the second sub-pixel (SP12) and the third sub-pixel (SP13) may be controlled by a same sub-sensing line.

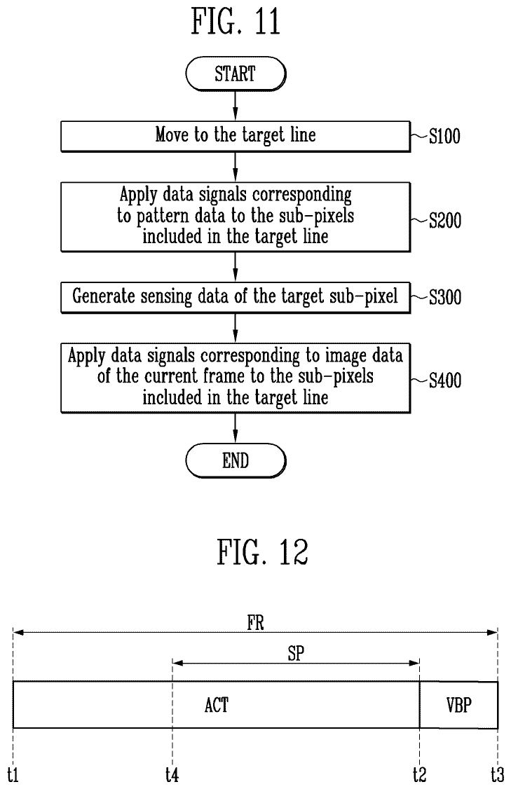

FIG. 11 is a flowchart illustrating an embodiment of a sensing operation of the display device of FIG. 1.

In an embodiment of a sensing operation of the display device, the display device may move to a target line (S100). The target line may refer to a sub-pixel row including a target sub-pixel that is the target of a sensing operation. In embodiments, the display device 10 may move to the target line by outputting gate signals to first to m^{th} gate lines 10 (GL1 to GLm) via the gate driver 200. Operation S100 may be referred to as a target line movement process.

In an embodiment, for example, referring to FIG. 6, where the target line is a third sub-pixel row, the display device 10 may move to the third sub-pixel row by sequentially supplying gate signals to first to third gate lines.

As the target line, one sub-pixel row per frame may be selected. In embodiments, one of the sub-pixel rows included in a display panel may be selected as the target line.

In other embodiments, one of the sub-pixel rows included in one row group among a plurality of row groups may be selected as the target line. In such embodiments, the position of the sub-pixel row selected as the target line may be fixed.

In an embodiment, for example, where the display panel includes first to sixth sub-pixel rows, a first row group includes the first to third sub-pixel rows, a second row group includes the fourth to sixth sub-pixel rows, and the position of the sub-pixel row selected as the target line is fixed to a first sub-pixel row for each row group, either the first sub-pixel row of the first row group or the fourth sub-pixel row of the second row group may be determined to be the target line.

In an embodiment of a sensing operation of the display device, the display device 10 may apply data signals corresponding to pattern data (GB) to sub-pixels (SPs) included in the target line, via the data lines (DL1 to DLm) during the blank interval (S200). Among the sub-pixels (SPs) included in the target line, a sub-pixel to which data signal with grey gradation is applied may be a target sub-pixel. The target sub-pixel may be a sub-pixel that is the target of a sensing operation.

The display device 10 may output data signals to the data lines (DL1 to DLm) via the data driver 400. Operation S200 may be referred to as a pattern data storage process.

In an embodiment of a sensing operation of the display device, the display device 10 may generate sensing data of the target sub-pixel (S300). In embodiments, the display device 10 may output a light-emitting control signal and a gate signal to the sub-pixels

(SPs) included in the target line via the gate driver 200 and the emission driver 300. In such embodiments, the target sub-pixel may generate a driving current (i.e., sensing current) based on a data signal with a grey gradation. Based on the sensing current of the target sub-pixel, the display device 10 may generate sensing data via the sensing driver 500. Operation S300 may be referred to as a sensing data generation process.

In embodiments, before operation S300 is performed, the display device 10 may output a reset signal (RS) of FIG. 8 to the reset switch (SW_RST) of FIG. 8. That is, in operation S100 or operation S200, the display device 10 may output a reset signal (RS) of FIG. 8 to the reset switch (SW_RST) of FIG. 8.

As the reset switch (SW_RST) is turned on in response to the reset signal (RS), a voltage of the ground power supply may be applied to the sensing node (SD) of FIG. 8. Accordingly, the accuracy of the sensing data generated in operation S300 may be improved.

In an embodiment of a sensing operation of the display device, to the sub-pixels (SPs) included in the target line, the display device 10 may apply data signals corresponding to image data (RGB) displayed during an active interval of a current frame (S400). Operation S400 may be referred to as an image data storage process.

FIG. 12 is a schematic diagram illustrating an operation of moving to a target line.

Referring to FIG. 12, a frame (FR) may include an active interval (ACT) and a blank interval (VBP).

The active interval (ACT) may be the interval between a first time point (t1) and a second time point (t2), and the blank interval (VBP) may be the interval between the second time point (t2) and a third time point (t3).

The frame (FR) may further include a movement interval (SP). The movement interval (SP) may be an interval in which operation S100 of FIG. 11 is performed. The movement interval (SP) may be the interval between a fourth time point (t4) and the second time point (t2).

As the target line is located closer to the end of the display panel 100, the length of the movement interval (SP) may be longer. That is, the fourth time point (t4) may be brought forward. Accordingly, the fourth time point (t4) may be moved (or set to be) closer to the first time point (t1) as the target line is located closer to the end of the display panel 100.

As the target line is located closer to the top of the display panel 100, the length of the movement interval (SP) may be shorter. That is, the fourth time point (t4) may be delayed. Accordingly, the fourth time point (t4) may be moved closer to the second time point (t2) as the target line is located closer to the top of the display panel 100.

In an embodiment, for example, referring to FIG. 6, the length of the movement interval (SP) when a first sub-pixel row is the target line may be shorter than when a third sub-pixel row is the target line. The fourth time point (t4) when the first sub-pixel row is the target line may be closer to the second time point (t2), compared to the case where the third sub-pixel row is the target line.

Although FIG. 12 shows an embodiment where the movement interval (SP) is defined before the blank interval (VBP), this disclosure is not limited thereto, and the movement interval (SP) may be located across the active interval (ACT) and the blank interval (VBP) according to embodiments.

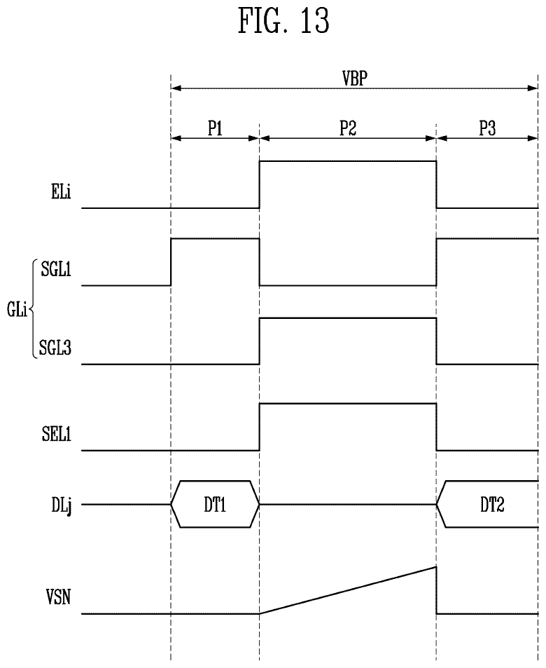

FIG. 13 is a signal timing diagram illustrating an example of driving a sub-pixel included in a target line during a blank interval. Referring to FIG. 13, the blank interval (VBP) may include first to third intervals (P1 to P3).

In FIG. 8, FIG. 9, and FIG. 11, signals applied to a first sub-pixel (SP11) that is a target sub-pixel, during the first to third intervals (P1 to P3) are shown. In FIG. 13, for clarity and conciseness, a description of the signal applied to a second sub-gate line is omitted.

The first interval (P1) may be an interval in which operation S200 of FIG. 11 is performed.

During the first interval (P1), a light-emitting control signal of an i^{th} light-emitting control line (ELi), a third sub-gate signal of a third sub-gate line (SGL3) of an i^{th} gate line (GLi), and a first selection signal may have a low voltage level. A first sub-gate signal of a first sub-gate line (SGL1) of the i^{th} gate line (GLi) may have a high voltage level.

During the first interval (P1), a second transistor (T2) may be turned on, a fifth transistor (T5) may be turned off, and a first selection switch (SW_SEL1) may be turned off. Accordingly, a first data signal (DT1) may be provided to a second node (N2). The first data signal (DT1) may be a data signal that corresponds to the pattern data (GB) of a current frame.

In this instance, the i^{th} light-emitting control line (ELi) and the i^{th} gate line (GLi) may be connected to a sub-pixel row including a target sub-pixel (e.g., the first sub-pixel (SP11)). In addition, the pattern data (GB) applied to the first sub-pixel (SP11) may have a grey gradation.

The second interval (P2) may be the interval in which operation S300 of FIG. 11 is performed.

During the second interval (P2), a light-emitting control signal of the i^{th} light-emitting control line (ELi), a third sub-gate signal of the third sub-gate line (SGL3) of the i^{th} gate line (GLi), and a first selection signal may have a high voltage level. A first sub-gate signal of the first sub-gate line (SGL1) of the i^{th} gate line (GLi) may have a low voltage level.

During the second interval (P2), the second transistor (T2) may be turned off, a fourth transistor (T4) and the fifth transistor (T5) may be turned on, and the first selection switch (SW_SEL1) may be turned on. Accordingly, a first sensing current of the first sub-pixel (SP11) may be applied to the sensing node (SD) of FIG. 8 via the first sub-sensing line (S11). A sensing voltage (VSN) may be a voltage charged by the sensing capacitor (Csn) of FIG. 8 when the first sensing current is applied to the sensing node (SD).

The calculation circuit 513 may generate sensing data based on the first sensing current (or sensing voltage (VSN)). The generated sensing data may be provided to the controller 600.

The third interval (P3) may be the interval in which operation S400 of FIG. 11 is performed.

During the third interval (P3), a light-emitting control signal of the i^{th} light-emitting control line (ELi), a third sub-gate signal of the third sub-gate line (SGL3) of the i^{th} gate line (GLi), and a first selection signal may have a low voltage level. A first sub-gate signal of the first sub-gate line (SGL1) of the i^{th} gate line (GLi) may have a high voltage level.

During the third interval (P3), the second transistor (T2) may be turned on, the fifth transistor (T5) may be turned off, and the first selection switch (SW_SEL1) may be turned off. Accordingly, a second data signal (DT2) may be provided to the second node (N2). The second data signal (DT2) may be a data signal corresponding to the image data (RGB) of the current frame.

In embodiments, where one of the sub-pixel rows included in one row group among a plurality of row groups is selected as the target line, a gate driver, an emission driver, and a data driver for generating sensing data for each of the plurality of row groups may be disposed separately from a gate driver, emission driver, and data driver operating in an active interval.

In addition, in embodiments, the gate driver, emission driver, and data driver for generating sensing data for each of the plurality of row groups may be disposed on the left and right sides of a display panel.

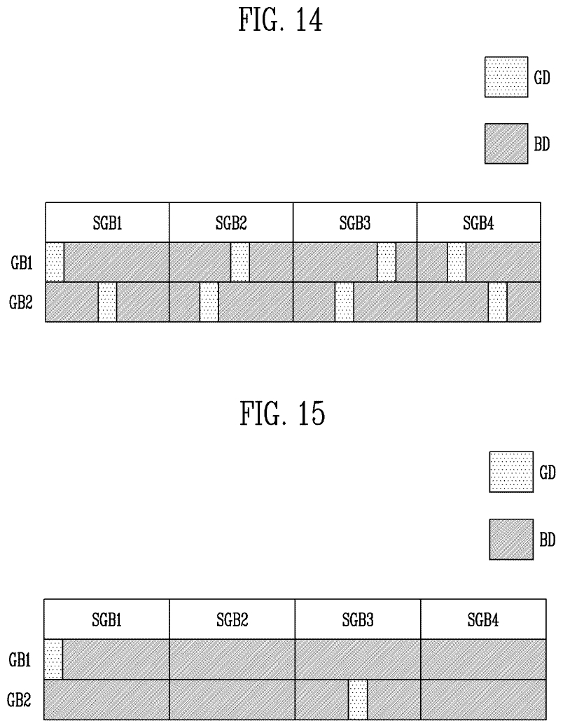

FIG. 14 is a drawing illustrating an embodiment of pattern data.

In FIG. 14, first pattern data (GB1) and second pattern data (GB2) are illustrated. The first pattern data (GB1) is pattern data that is applied to the target line in a first frame, and the second pattern data (GB2) is pattern data that is applied to a target line in a second frame, which is different from the first frame.

Each of the first pattern data (GB1) and the second pattern data (GB2) may include first to fourth sub-data (SGB1 to SGB4). Referring back to FIG. 5, the first sub-data (SGB1) may be applied to a target line of a first block (BL1), the second sub-data (SGB2) may be applied to a target line of a second block (BL2), the third sub-data (SGB3) may be applied to a target line of a third block (BL3), and the fourth sub-data (SGB4) may be applied to a target line of a fourth block (BL4).

Each of the first to fourth sub-data (SGB1 to SGB4) may include black gradation data (BD) and grey gradation data (GD). The black gradation data (BD) may be data with black gradation (grayscale level), and the grey gradation data (GD) may be data with grey gradation.

The grey gradation data (GD) may be applied to a target sub-pixel in a target line, and the black gradation data (BD) may be applied to sub-pixels other than the target sub-pixel in the target line.

In embodiments, each of the first to fourth sub-data (SGB1 to SGB) of the first pattern data (GB1) may have different patterns. That is, the target sub-pixel of each of the first to fourth blocks (BL1 to BL4) may be disposed in different sub-pixel columns.

In an embodiment, for example, the target sub-pixel of the first block (BL1) may be disposed in a first sub-pixel column, and the target sub-pixel of second block (BL2) may be disposed in a fourth sub-pixel column.

In embodiments, the target sub-pixel may be a sub-pixel selected by first to third selection signals (SEL1 to SEL3) of FIGS. 7 and 8. That is, based on the target sub-pixel determined by the first pattern data (GB1), first to third selection signals (SEL1 to SEL3) may be generated.

In an embodiment, for example, if the first sub-pixel (SP11) is the target sub-pixel, the grey gradation data (GD) may be applied to the first sub-pixel (SP11), and the first-selection signal (SEL1) may be applied to the first selection switch (SW_SEL1).

The second pattern data (GB2) may have a pattern different from the first pattern data (GB1). Accordingly, the target sub-pixel may be changed for each frame.

FIG. 15 is a drawing illustrating another embodiment of pattern data.

In FIG. 15, the first pattern data (GB1) and the second pattern data (GB2) are illustrated. The first pattern data (GB1) is pattern data that is applied to a target line in a first frame, and the second pattern data (GB2) is pattern data that is applied to a target line in a second frame, which is different from the first frame.

Each of the first pattern data (GB1) and the second pattern data (GB2) may include first to fourth sub-data (SGB1 to SGB4). Referring to FIG. 5, the first sub-data (SGB1) may be applied to a first block (BL1), the second sub-data (SGB2) may be applied to a second block (BL2), the third sub-data (SGB3) may be applied to a third block (BL3), and the fourth sub-data (SGB4) may be applied to a fourth block (BL4).

One of the first to fourth sub-data (SGB1 to SGB4) may include black gradation data (BD) and grey gradation data (GD), and the others may include only black gradation data (BD).

Accordingly, not all of the first to fourth blocks (BL1 to BL4) include a target sub-pixel, but only one of the first to fourth blocks (BL1 to BL4) may include a target sub-pixel.

In addition, the second pattern data (GB2) may have a pattern different from the first pattern data (GB1). Accordingly, the target sub-pixel may be different for each frame.

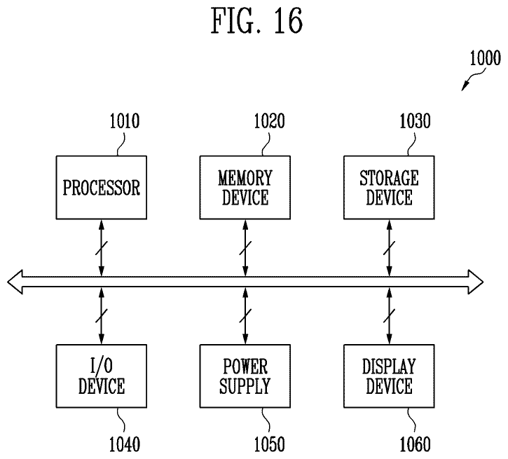

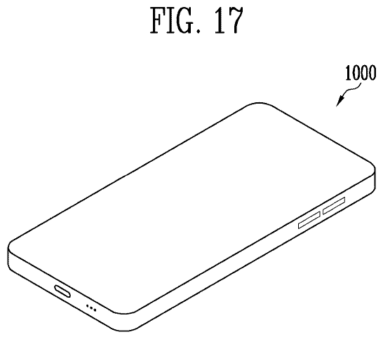

FIG. 16 is a block diagram illustrating an electronic device according to embodiments of the disclosure, and FIG. 17 is a diagram illustrating an embodiment of the electronic device of FIG. 16 implemented as a smartphone.

Referring to FIGS. 16 and 17, an embodiment of an electronic device 1000 may include a processor 1010, a memory device 1020, a storage device 1030, an input/output (I/O) device 1040, a power supply device 1050, and a display device 1060. In this instance, the display device 1060 may be the display device of FIG. 1. In addition, the electronic device 1000 may further include various ports capable of communicating with a video card, sound card, memory card, USB device, or other systems. In an embodiment, as illustrated in FIG. 17, the electronic device 1000 may be implemented as a smartphone. However, this is illustrative and is not limited to the electronic device 1000. In an embodiment, for example, the electronic device 1000 may be implemented as a mobile phone, video phone, smart pad, smart watch, tablet computer, vehicle navigation, computer monitor, laptop, head-mounted display device, etc.

The processor 1010 may perform predetermined calculations or tasks. Depending on embodiments, the processor 1010 may be a microprocessor, a central processing unit, an application processor, etc. The processor 1010 may be connected to other components via an address bus, a control bus, and a data bus. Depending on embodiments, the processor 1010 may be connected to an extension bus such as a peripheral component Interconnect (PCI) bus.

The memory device 1020 may store data used for the operation of the electronic device 1000. In an embodiment, for example, the memory device 1020 may be include non-volatile memory devices, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, polymer random access memory (PoRAM) device, magnetic random access memory (MRAM), a ferroelectric random access memory (FRAM) device and/or volatile memory devices, such as a dynamic random access memory (DRAM) device, a static random access memory (SRAM) device, a mobile DRAM devices, etc.

The storage device 1030 may include a solid state drive (SSD), hard disk drive (HDD), CD-ROM, etc.

The I/O device 1040 may include input means such as a keyboard, a keypad, a touchpad, a touchscreen, a mouse, etc., and output means such as a speaker, a printer, etc. Depending on embodiments, the display device 1060 may be included in the I/O device 1040.

The power supply device 1050 may provide a power supply required for the operation of the electronic device 1000. In an embodiment, for example, the power supply device 1050 may be a power management integrated circuit (PMIC).

The display device 1060 may display an image corresponding to the visual information of the electronic device 1000. In an embodiment, the display device 1060 may be either an organic light-emitting display device or a quantum dot light-emitting display device, but is not limited thereto. The display device 1060 may be connected to other components via the buses or other communication links.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel comprising a plurality of blocks, wherein each of the blocks comprises a plurality of sub-pixels; and
a sensing unit connected to a first block among the blocks via a sensing line, wherein sensing unit comprises a sensing capacitor,
wherein the sensing line comprises a first sub-sensing line connected to sub-pixels which emit light in a first color among sub-pixels included in the first block and a second sub-sensing line connected to sub-pixels which emit light in a second color different from the first color among the sub-pixels included in the first block,
the sensing unit further comprises:
a first initialization switch connected between a first initialization voltage node, to which a first initialization voltage is applied, and the first sub-sensing line; and
a second initialization switch connected between a second initialization voltage node, to which a second initialization voltage is applied, and the second sub-sensing line, and
the first initialization voltage and the second initialization voltage are different from each other.

2. The display device according to claim 1, wherein the sensing line further comprises a third sub-sensing line connected to sub-pixels which emit light in a third color different from the first color and the second color among the sub-pixels included in the first block,
the sensing unit further comprises a third initialization switch connected between a third initialization voltage node, to which a third initialization voltage is applied, and the third sub-sensing line, and
the first initialization voltage, the second initialization voltage, and the third initialization voltage are different from each other.

3. The display device according to claim 2, wherein the first to third initialization switches are turned on in response to a voltage application signal applied thereto during an active interval of a frame.

4. The display device according to claim 3, wherein the sensing unit further comprises:
a first selection switch connected between the first sub-sensing line and a sensing node, wherein the first selection switch is turned on in response to a first selection signal;
a second selection switch connected between the second sub-sensing line and the sensing node, wherein the second selection switch is turned on in response to a second selection signal; and
a third selection switch connected between the third sub-sensing line and the sensing node, wherein the third selection switch is turned on in response to a third selection signal, and the first to third selection signals are applied during a blank interval after the active interval.

5. The display device according to claim 4, wherein the sensing unit further comprises:
a reset switch connected between the sensing node and a ground power supply, wherein the reset switch is turned on in response to a reset signal; and
the sensing capacitor connected between the sensing node and the ground power supply.

6. The display device according to claim 5, wherein the sensing unit further comprises:
an analog front-end, to which the sensing node and a driving voltage node are connected at an input end thereof; and
an analog-to-digital converter which converts a voltage output from the analog front-end into a data value.

7. The display device according to claim 6, wherein, when the first selection switch is turned on, a first driving voltage is applied to the driving voltage node,
when the second selection switch is turned on, a second driving voltage is applied to the driving voltage node,
when the third selection switch is turned on, a third driving voltage is applied to the driving voltage node, and the first to third driving voltages are different from each other.

8. The display device according to claim 7, wherein the blank interval comprises a first interval, a second interval, and a third interval,
during the first interval, a data signal corresponding to pattern data is applied to sub-pixels included in a target sub-pixel row including a target sub-pixel,
during the second interval after the first interval, the target sub-pixel generates a driving current based on the pattern data, and the sensing unit generates sensing data based on the driving current,
during the third interval after the second interval, data signals corresponding to image data included in an active interval of a current frame are applied to the sub-pixels included in the target sub-pixel row, and
the target sub-pixel generates the driving current based on a data signal corresponding to data having a grey gradation in the pattern data.

9. The display device according to claim 8, wherein the sensing data includes electrical characteristics of the target sub-pixel.

10. The display device according to claim 9, wherein, in one frame, the target sub-pixel of each of the blocks is disposed in a different sub-pixel column.

11. The display device according to claim 8, wherein the pattern data comprises a plurality of sub-data applied to the target sub-pixel row,
each of the sub-data comprises first data having a black gradation and second data having the grey gradation,
the first data is applied to sub-pixels other than the target sub-pixel among the sub-pixels included in the target sub-pixel row, and
the second data is applied to the target sub-pixel among the sub-pixels included in the target sub-pixel row.

12. The display device according to claim 8, wherein the first to third selection signals are applied during the second interval, and
the reset signal is applied before the third interval.

13. An electronic device comprising:
a display panel comprising a plurality of blocks, wherein each of the blocks comprises a plurality of sub-pixels;
a data driver which supplies a data signal to the blocks via a plurality of data lines;
a gate driver which supplies sub-gate signals to the sub-pixels;
an emission driver which supplies light-emitting control signals to the sub-pixels; and
a sensing unit connected to a first block among the blocks via a sensing line, wherein the sensing unit comprises a sensing capacitor,
wherein each of the sub-pixels comprises:
a first transistor connected between a first power supply voltage node and a first node, wherein the first transistor comprises a gate electrode connected to a second node;
a second transistor connected between the second node and a data line, wherein the second transistor is turned on based on a first sub-gate signal among the sub-gate signals;
a third transistor connected between the first power supply voltage node and the first transistor, wherein the third transistor is turned on based on a light-emitting control signal;
a fourth transistor connected between the first node and the sensing line, wherein the fourth transistor is turned on based on a second sub-gate signal among the sub-gate signals;
a storage capacitor connected between the first node and the second node; and
a light-emitting element connected between the first node and a second power supply voltage node,
the sensing line comprises a first sub-sensing line connected to sub-pixels which emit light in a first color among sub-pixels included in the first block, and a second sub-sensing line connected to sub-pixels which emit light in a second color different from the first color among the sub-pixels included in the first block, and
a first initialization voltage applied to the first sub-sensing line and a second initialization voltage applied to the second sub-sensing line are different from each other.

14. The electronic device according to claim 13, wherein the sensing line further comprises a third sub-sensing line connected to sub-pixels which emit light in a third color different from the first color and the second color among the sub-pixels included in the first block, and
a third initialization voltage applied to the third sub-sensing line, the first initialization voltage, and the second initialization voltage are different from each other.

15. The electronic device according to claim 14, wherein a blank interval of a frame comprises a first interval, a second interval, and a third interval,
during the first interval, a data signal corresponding to pattern data is applied to sub-pixels included in a target sub-pixel row including a target sub-pixel,
during the second interval after the first interval, the target sub-pixel generates a driving current based on the pattern data, and the sensing unit generates sensing data based on the driving current,
during the third interval after the second interval, data signals corresponding to image data included in an active interval of a current frame are applied to the sub-pixels included in the target sub-pixel row, and
the target sub-pixel generates the driving current based on a data signal corresponding to data having a grey gradation in the pattern data.

16. The electronic device according to claim 15, wherein the sensing data includes electrical characteristics of the target sub-pixel.

17. The electronic device according to claim 15, wherein, in one frame, the target sub-pixel of each of the blocks is disposed in a different sub-pixel column.

18. The electronic device according to claim 15, wherein the pattern data comprises a plurality of sub-data applied to the target sub-pixel row,
each of the sub-data comprises first data having a black gradation and second data having the grey gradation,
the first data is applied to sub-pixels other than the target sub-pixel among the sub-pixels included in the target sub-pixel row, and
the second data is applied to the target sub-pixel among the sub-pixels included in the target sub-pixel row.

19. The electronic device according to claim 15, wherein, during the first interval, the first sub-gate signal has a turn-on level, and a data signal corresponding to the pattern data is applied to the data line,
during the second interval, the second sub-gate signal and the light-emitting control signal have turn-on levels, and
during the third interval, the first sub-gate signal has a turn-on level, and a data signal corresponding to image data included in an active interval of a current frame is applied to the data line.

20. An operation method of a sensing unit connected to a block, which comprises a plurality of sub-pixels, via a sensing line, the method comprising:
during an active interval of a frame, applying first to third initialization voltages to the sub-pixels via the sensing line; and
during a blank interval of the frame, generating sensing data including electrical characteristics of a target sub-pixel among sub-pixels connected via the sensing line,
wherein the first initialization voltage applied to sub-pixels which emit light in a first color among the sub-pixels, the second initialization voltage applied to sub-pixels which emit light in a second color different from the first color among the plurality of sub-pixels, and the third initialization voltage applied to sub-pixels which emit light in a third color different from the first color and the second color among the sub-pixels are different from each other.
